(19) United States
(12) Patent Application Publication
(10) Pub. No.: US 2008/0215352 A1
(43) Pub. Date: Sep. 4, 2008

(54) METHOD AND APPARATUS FOR RECRUITING STUDENTS

(75) Inventors: Michael Miles, Barrington, IL (US); Karen Browne, Chicago, IL (US); Mitchell Greenwald, Glenview, IL (US)

Correspondence Address: BELL, BOYD & LLOYD, LLP, P.O. Box 1135, CHICAGO, IL, 60690, US

(73) Assignee: Seaton Corp., Chicago, IL (US)

(21) Appl. No.: 12/027,845

(22) Filed: Feb. 7, 2008

Related U.S. Application Data
(60) Provisional application No. 60/888,705, filed on Feb. 7, 2007.

(51) Int. Cl. G06Q 10/00; G06Q 90/00; G09B 7/00; G09B 25/00

(52) U.S. Cl. 705/1; 434/362; 434/365

(57) ABSTRACT

The present disclosure provides methods and apparatuses for recruiting students. Using the methods and apparatus disclosed herein, educators can more efficiently recruit prospective students. Educational institutions can increase the efficiency of recruitment efforts by automatically generating outbound calls to prospective students. Outbound calls to prospective students are automatically generated when a prospective student is directed to call a recruitment center and the prospective student fails to call within a set time period. Outbound calls to prospective students are also automatically generated when a student is performing an online process to set an appointment and requests an immediate call. In addition, educational institutions can simplify the appointment scheduling process by incorporating an administrator's schedule into a student database. The student database may contain a list associated with a prospective student's preferred interview times, as well as a list of the administrator's available times. The present disclosure provides a method for presenting times to the student that are only present on both lists.

### PRIORITY CLAIM

This application is a non-provisional of, claims priority to and the benefit of U.S. Provisional Patent Application Ser. No. 60/888,705 filed Feb. 7, 2007, the entire contents of which are incorporated herein by reference.

### BACKGROUND

The recruitment and retention of students is a time consuming and expensive process at all levels of education. Often, a prospective student or his or her guardians view a static website for an educational institution. The static website generally provides basic information about the educational institution to the student. However, the static website does not capture information about the student. This limited interaction does not allow the educational institution to fully capture detailed information about the student.

Other educational institutions have dynamic websites that capture some prospective student information. These dynamic websites typically have the prospective student fill a form out requesting basic information in addition to prospective student information, such as their prospective area of study, etc. In return, a brochure or booklet may be delivered to the student. These websites allow the educational institution to capture certain metrics, such as the number of students requesting certain information and/or geographic data regarding the prospective students. However, these dynamic websites are only able to capture information about the student that the website is preprogrammed to capture.

In order to improve the flexibility and interactively of this process, some educational institutions have recruitment offices, where recruitment officers are able to answer a prospective student's questions and ask unrehearsed questions. A prospective student may call the recruitment office, for example after visiting the educational institution's dynamic website, to obtain more information about the educational institution. A prospective student may also wish to speak with a recruitment officer about the prospective student's options and/or to schedule an interview. When a prospective student requests an interview with an admissions officer, the recruitment officer may be able to provide the prospective student with the admissions officer's availability. Often, the recruitment officer can access the admissions officer's schedule over an internal network. However, this system is more time consuming for the student than necessary. Due to lack of network integration, if a student has already provided their availability by entering it on the dynamic website, that information may be unavailable to the recruitment officer.

Additionally, in some cases, students are asked to call a recruitment office in order to schedule an appointment. For various reasons, the student may not call the recruitment office. For example, the prospective student may forget to call, or the student may feel unsure about their admissions prospects and not wish to call. A recruitment officer may independently call the prospective student. However, many prospective students are never contacted because of the informal process that a recruitment officer uses to decide when to call a prospective student. Additionally, the recruitment officer may call the prospective student after the prospective student has decided to attend another educational institution, due to the delay between the prospective student's contact and the recruitment officer's subsequent call.

### SUMMARY

The present disclosure provides methods and apparatuses for recruiting students. Using the methods and apparatus disclosed herein, educators can more efficiently recruit prospective students. First, educational institutions can increase the efficiency of recruitment efforts by automatically generating time-based outbound calls to prospective students. Outbound calls to prospective students are automatically generated when a prospective student is directed to call a recruitment center, and the prospective student fails to call within a set time period.

In addition, educational institutions can simplify the appointment scheduling process by incorporating an administrator's schedule into a student database. The student database may contain a list associated with a prospective student's preferred interview times, as well as a list of the administrator's available times. The present disclosure provides a method for presenting times to the student that are only present on both lists. Using these methods, an administrator can save time and focus on higher level issues.

### BRIEF DESCRIPTION OF THE FIGURES

FIG. 1 is a high level block diagram of an example communications system

FIG. 2 is a more detailed block diagram showing one example of a client device.

FIG. 3 is a more detailed block diagram showing one example of a server.

FIG. 4 is a flowchart of an example process for automatically generating a time-based outbound call from a call center to a prospective student.

FIG. 5 is a flowchart of an example prospective student flow.

FIG. 6 is a flowchart of an example process for scheduling an appointment.

FIG. 7 is a screenshot of an example student request page.

FIG. 8 is a screenshot of an example call request page.

FIG. 9 is a screenshot of an example filtering question page.

FIG. 10 is a screenshot of an example appointment scheduling page.

FIG. 11 is a screenshot of an example instruction page.

FIG. 12 is a screenshot of an example confirmation page.

### DETAILED DESCRIPTION

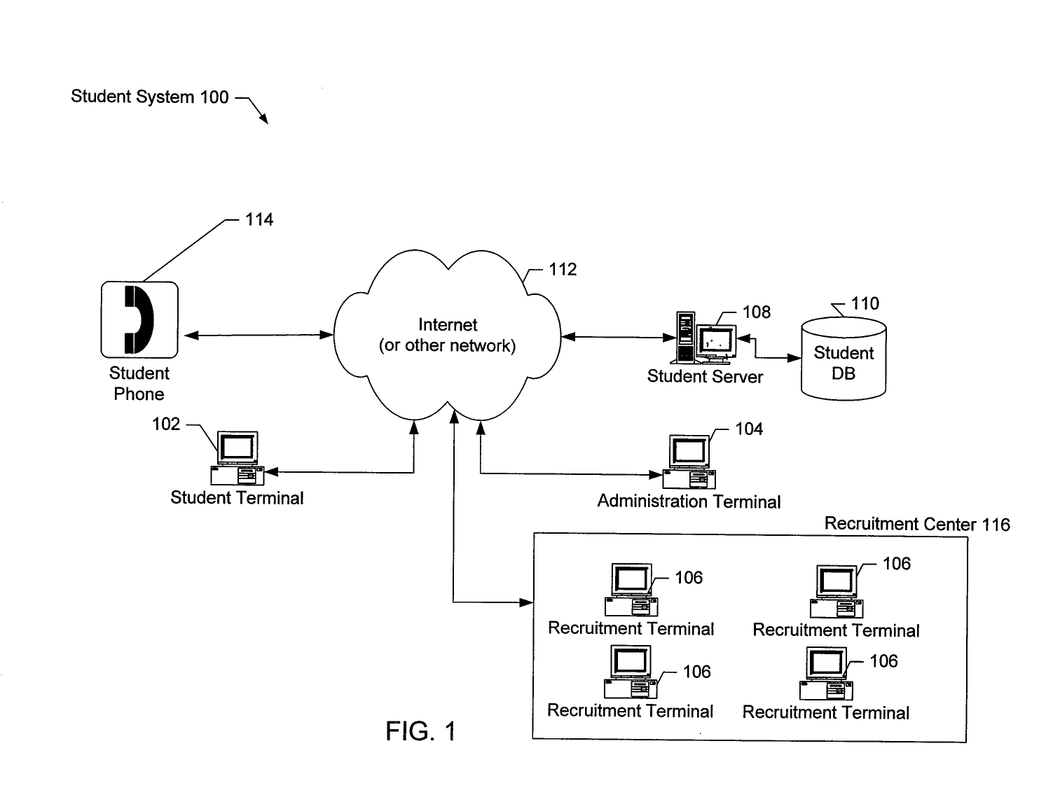

The present system is most readily realized in a network communications system. A high level block diagram of an exemplary network communications system 100 is illustrated in FIG. 1. The illustrated system 100 includes one or more student terminals 102, one or more administration terminals 104, one or more recruitment terminals 106 located at one or more recruitment centers 116, one or more student servers 108, one or more student phones 114 and one or more student databases 110. Each of these devices may communicate with each other via a connection to one or more communications channels 112 such as the Internet or some other data network, including, but not limited to, any suitable wide area network or local area network. It will be appreciated that any of the devices described herein may be directly connected to each other instead of over a network.

The student server 108 stores a plurality of files, programs, and/or web pages in one or more databases 110 for use by the student terminals 102, the administration terminals 104, and/or the recruitment terminals 106. The database 110 may be connected directly to the student server 108 and/or via one or more network connections. The database 110 preferably stores student information, including, but not limited to student addresses, student interests, media codes, contact history, filtering questions, student answers to filtering questions, etc. The contact history may include a time stamped track of when the student first contacted the institution, if the student scheduled an interview, interview notes, enrollment date, etc.

One student server 108 may interact with a large number of terminals. Accordingly, each student server 108 is typically a high end computer with a large storage capacity, one or more fast microprocessors, and one or more high speed network connections. Conversely, relative to a typical student server 108, each student terminal 102, administration terminal 104, or recruitment terminal 106 typically includes less storage capacity, a single microprocessor, and a single network connection.

One or more recruitment terminals 106 may be located at a recruitment center 116. Accordingly, each recruitment terminal is typically similar in nature.

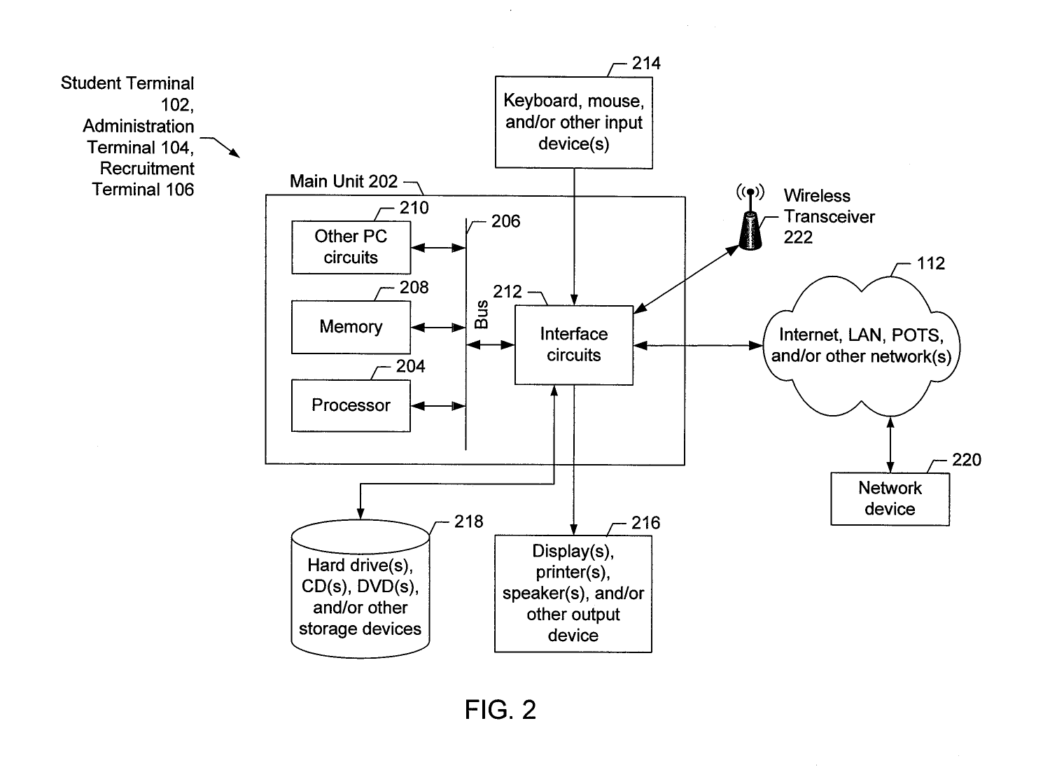

A more detailed block diagram of a student terminal 102, administration terminal 104 or recruitment terminal 106 is illustrated in FIG. 2. The student terminal 102, administration terminal 104 or recruitment terminal 106 may include a personal computer (PC), a personal digital assistant (PDA), an Internet appliance, a cellular telephone, or any other suitable communication device. The student terminal 102, administration terminal 104 or recruitment terminal 106 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the student terminal 102, administration terminal 104 or recruitment terminal 106. For example, the display 216 may be used to display web pages received from the student server 108. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the student terminal 102, administration terminal 104 or recruitment terminal 106.

The student terminal 102, administration terminal 104 or recruitment terminal 106 may also exchange data with other network devices 220 via a connection to the network 112. The network connection may be any type of network connection, such as an Ethernet connection, digital subscriber line (DSL), telephone line, coaxial cable, etc. Users of an administrator terminal 104 or recruitment terminal 106 may be required to register with the student server 108. In such an instance, each user of an administrator terminal 104 or recruitment terminal 106 may choose a user identifier (e.g., e-mail address) and a password which may be required for the activation of services. The user identifier and password may be passed across the network 112 using encryption built into the administrator terminal's 104 browser or the recruitment terminal's 106 browser. Alternatively, the user identifier and/or password may be assigned by the student server 108.

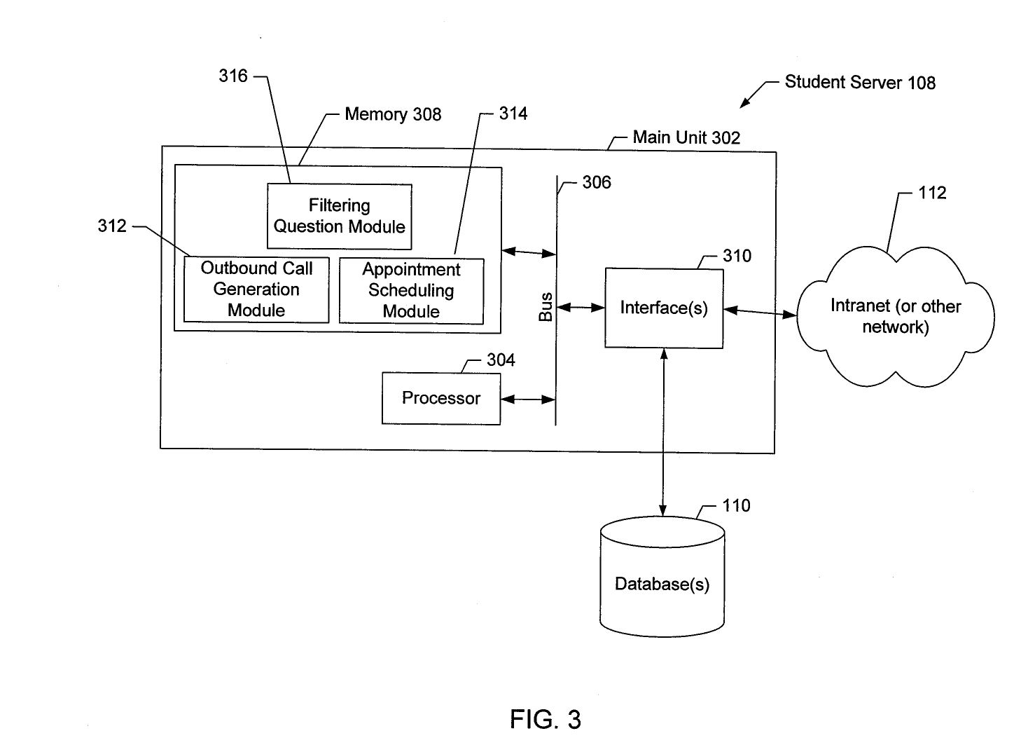

A more detailed block diagram of a student server 108 is illustrated in FIG. 3. Like the student terminal 102, administration terminal 104 or recruitment terminal 106, the main unit 302 in the student server 108 preferably includes a one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

In particular, the memory preferably stores an outbound call generation module 312, an appointment scheduling module 314, and a filtering question module 316. The outbound call generation module 312 determines if an outbound call to the student phone 114 should be made, based on information associated with the student and a set time period. The appointment scheduling module 314 is configured to determine one or more times when a student and an administrator are both available to meet for an appointment.

The filtering question module 316, determines which questions to present to the student. For example, if the student is at a student terminal 102, and is accessing the student server 108, the filtering question module 316 may transmit a first filtering question to the student terminal 102 from the student server 108. If the student calls the recruitment center 116, the filtering question module 316 may transmit a first filtering questions to the recruitment terminal 106. The filtering question module 316 receives the data associated with a student's response to the first filtering question. The filtering question module 316 may determine the next question to present to the student. For example, the first question may be “Have you graduated from High School?,” and “Yes” and “No” as options presented to the student. If the student selects “No”, the data associated with the student's response may be transmitted from the student terminal 102 to the student server 108. The filtering question module 316 may then cause the student server 108 to transmit, “Do you have a GED?” to the recruitment terminal 106 or the student terminal 102.

These software modules 312, and 314 may be executed by the processor 304 in a conventional manner. However, some of the acts described in the method below may be performed manually or without the use of the student server 108. The memory device 308 and/or a separate database 110 also store files, programs, web pages, etc. for use by other student servers 108, student terminals 102, administration terminals 104, and/or recruitment terminals 106.

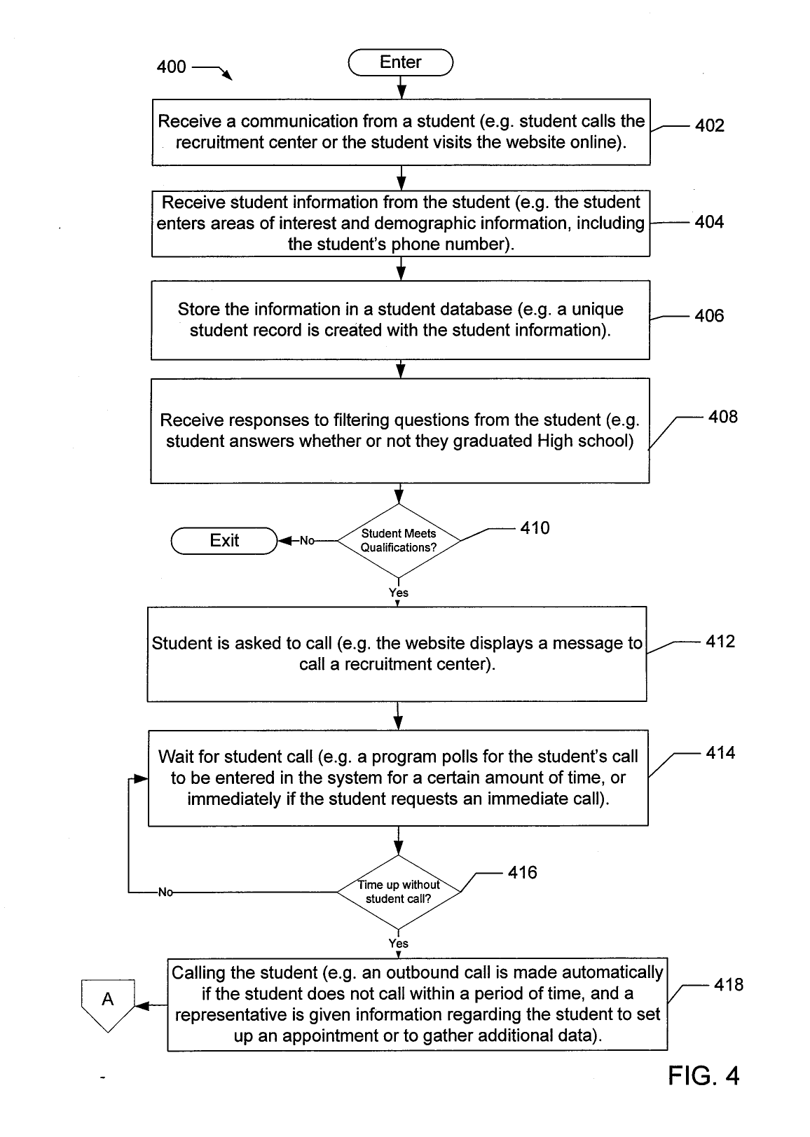

A flowchart of an example process 400 for automatically generating a time-based outbound call is shown in FIG. 4. Preferably, the process 400 is embodied in one or more software programs stored in one or more memories and executed by one or more processors. Although the process 400 is described with reference to the flowchart illustrated in FIG. 4, it will be appreciated that many other methods of performing the acts associated with process 400 may be used. For example, the order of many of the acts may be changed, and some of the acts described may be optional.

In this example, the process 400 receives a communication from a student (block 402). For example, the student places a phone call via the student phone 114 to a recruitment officer, who is sitting at a recruitment terminal 106 at the recruitment center 116.

In another example, the student accesses the student server 108 to interact with a recruitment website, as discussed in further detail below. For example, the student may see an advertisement with a media code, discussed in further detail below, and a web address for the recruitment website. If the student was interested in the educational institution, the student could enter the web address into a browser on their student terminal 102.

The media code may be any code that identifies the advertisement. For example, a television advertisement may have an alphanumeric code such as “1C5×23,” and a newspaper print advertisement may have an alphanumeric code such as “N20D2E.” It will be readily appreciated that the media code may any suitable alphanumeric combination, including wholly alphabetic combinations and wholly numeric combinations.

In another example, the student accesses the recruitment website from the educational institution's home website directly, or from other pages in the educational institution's website, or via a search engine. For example, the institution's home website, or other pages in the educational institution's website, may contain a link to the recruitment website. For example, the student may view the educational institution's home website, hosted by the student server 108, on the student terminal 102, and the student may click a link titled “Find out More.”

The process 400 then receives information from the student (block 404). For example, the student may enter information into a form on the recruitment website. The information may be geographic information, address and phone number information, educational history information, the media code, appointment availability, etc. The information on the form may be transmitted from the student terminal 102 to the student server 108, via the internet or other network 112. The student server 108 may store the transmitted information.

In another example, a student calls a recruitment officer at a recruitment terminal 106 in a recruitment center 116. The recruitment terminal 106 may display a static list of filtering questions to the recruitment officer. For example, the recruitment terminal 106 may display “Have you graduated from High School?,” “What do you want to major in?,” etc.

In another example, the recruitment terminal 106 displays a series of dynamic filtering questions to the recruitment officer based on the recruitment officer's input. For example, the recruitment terminal 106 may display “Have you graduated from High School?,” and “Yes” and “No” as options for the recruitment officer to choose. Upon choosing “No” the recruitment terminal 106 may then display, “Do you have a GED?” The recruitment officer's inputs into the recruitment terminal 106 are transmitted to the student server 108 via the internet or other network 112.

Some of the information may be automatically retrieved. For example, the student server 108 may automatically retrieve certain information based on the prospective student's phone number by connecting to a third party database via the internet or other network 112. The information retrieved may be any suitable information associated with the prospective student such as geographic information associated with the prospective student's residence, media code, lead type, etc.

In another example, a series of filtering questions is displayed to the student at the student terminal 102, and the process 400 receives answers to the questions. For example, the student server 108 may transmit a form asking, “Have you graduated from High School?” with the options of “Yes” and “No” to the student terminal 102. If the student chooses “No” by clicking on the link, or via another input method, the student server 108 may transmit another form with the question, “Do you have a GED?” to the student terminal 102.

If a student does not answer all of the questions or leaves the system before completing the questions, that information is stored by the student server 108, in a student database 110, in order to better tailor questions and determine which questions or what number of questions users stop at.

The media code may be stored, and the processor 304 may perform an analysis to determine the appropriate administrator and program for the student, based on the media code. For example, the media code may be associated with a particular administrator and a specific educational program.

The contact history analysis module 314 may lead type a student to determine how the prospective student heard about the educational institution. Lead typing associates a prospective student with a particular media advertisement for tracking purposes.

The process 400 then stores the student information in the student database 110 (block 406). Preferably, the student information is stored with a unique identifier. The unique identifier could be the student name, phone number, email address, etc. Additionally, separate tables could capture different information such as demographics, referrals, interests, filtering question answers, etc. The student database 110 may also incorporate admissions officer schedule information. The admissions officer schedule information is a listing of available appointment times with admissions officers. The student database 110 may also track a student's enrollment and progression through the educational institution.

The process 400 receives responses to filtering questions from the student (block 408). For example, the student server 108 may transmit forms containing questions regarding the student's interests, ability to pay, educational history, etc.

The process 400 then decides whether the student meets the educational institutions qualifications, based on the filtering questions (block 410). For example, the educational institution may only accept students that have graduated from High school. If the prospective student does not have the proper qualifications, the system creates a flag to call the student in the future. For example, the student server 108 may determine that the prospective student will graduate high school in two years and create a flag on the prospective student's file. The student server 108 may also associate qualification information with the student. For example, the student server 108 may store information indicating that the system should call the student in two years. The system may wait for the proper amount of time before generating a call, as described below in relation to block 414.

If the prospective student has the proper qualifications, the student is asked to call into the recruitment center 116 (block 412). For example, the student server 108 transmits a message to the student terminal 102 for the student to contact a recruitment officer at a recruitment center 116. In another example, a recruitment officer at a recruitment center 116 asks the student to call and make an appointment. If the student is not ready to make an appointment, the recruitment officer can tell the student to call back when he or she is ready. In such an instance, the recruitment officer preferably enter a note into the student database 110 indicating the student did not set an appointment. For example, the student database 110 may have a flag associated with the student to signify that a call is expected from the student at the recruitment center 116. The flag is then transmitted to the student server 108 via the internet or other network 112 and stored by the student server 108 on the student database 110.

The process 400 then waits for the student to call the recruitment center 116 (block 414). Preferably, a process running on the student server 108 periodically checks for a notification that the student has called into the system. For example, the notification may be a flag in student database 110 being set to on or off.

The amount of time to wait for a call from the student may be entered by the recruitment officer into the recruitment terminal 106 and transmitted to the student server 108 via the internet or other network 112. For example, the student may say that they are going to call back in two weeks. In this example, the recruitment officer may enter two weeks into a field on a page on his or her recruitment terminal 106 and transmit that information to the student server 108. A modifiable time limit may be allowed for the student to call in. For example, the time limit may be set by default to two weeks and then modified by a recruitment officer to one week.

The student may also be able to request an immediate call. For example, the student may choose an option on the recruitment website for an immediate call. The student's choice is transmitted from the student terminal 102 to the student server 108. The student server 108 may then immediately generate an outbound call. Generating an outbound call is described below in relation to block 418.

The process 400 then determines whether the time limit has passed without a student call (block 416). For example, a time sensitive trigger may cause a program to analyze the student database 110 in order to determine if a flag has been set. The flag indicates whether the student called the recruitment center 116. The recruitment officer may enter notes about the call into the recruitment terminal 106. The recruitment officer may also mark a flag indicating that the student called the recruitment center 116. The recruitment terminal 106 may transmit the notes and the flag to the student server 108. The student server 108 may store the notes as well as the flag in a data entry associated with the student. If the time limit has not passed, then the process returns to waiting for the student call (block 414).

If the time limit has passed, then the process 400 calls the student (block 418) and an outbound call is automatically generated. For example, after the set time period has passed, the polling process may analyze the prospective student's account in the student database 110. If the process determines that the student has not called, the student server 108 may begin an outbound phone call to the phone number provided by the student. The student's selections may determine at what time of day the phone call is made. For example, if the prospective student selected to be called in the evening, on the recruitment website, a call will only be made in the evening.

Information regarding the student may be sent from the student server 108 to the recruitment center 116. For example, the call may be assigned to a recruitment officer by the student server 108. The student server 108 may send information regarding the student from the student database 110. The information from the student database 110 is then displayed on the recruitment terminal 106. For example, the student server 108 may retrieve information regarding the prospective student's responses to the filtering questions and geographic information from the student database 110. The student server 108 then and transmits this information to the recruitment terminal 106 via the internet or other network 112.

A recruitment officer may speak with the student to schedule an appointment if needed, collect additional information if needed, or provide information, etc. For example, the recruitment officer may inform the student as to certain programs at the educational institution.

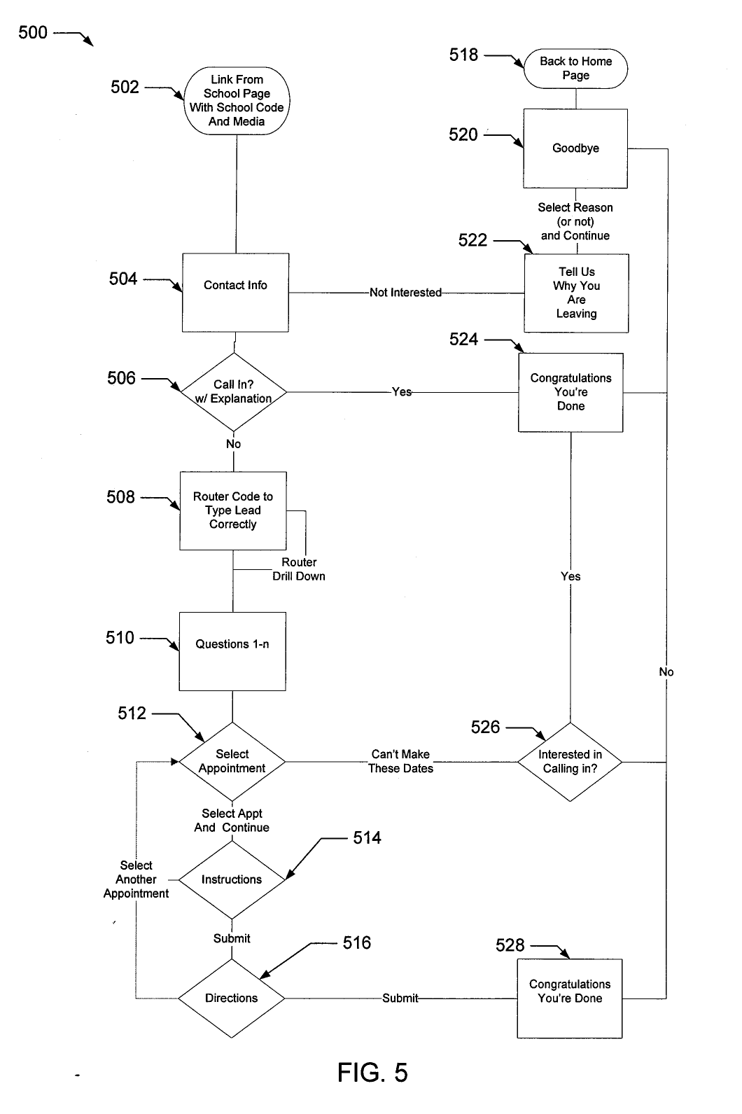

A flowchart of an example process 500 that a prospective student would traverse is shown in FIG. 5. Preferably, the process 500 is embodied in one or more software programs which is stored in one or more memories and executed by one or more processors. Although the process 500 is described with reference to the flowchart illustrated in FIG. 5, it will be appreciated that many other methods of performing the acts associated with process 500 may be used. For example, the order of many of the acts may be changed, and some of the acts described may be optional. Additionally many other acts may be added to the process 500.

In this example, a student enters the web flow through a link on a school page (block 502). The link may send a school code and the media code to the student server 108. For example, a website containing links to various educational institutions may contain a link to the recruitment website of an educational institution. The link may automatically submit the school code and the media code to the student server 108 via the internet or other network 112. The school code may be an alphanumeric sequence that uniquely identifies an educational institution. The school code may also be an alphanumeric sequence that uniquely identifies a collection of educational institutions. In another example, the student enters this information manually.

The student then enters their contact information (block 504). For example, the student terminal 102 displays a form requesting the student's contact information. In this example, the student enters their information and submits the form, which sends the information from the student terminal 102 to the student server 108.

If the student does not complete their contact information, the student server 108 may transmit a screen that asks follow-up questions as to why they are leaving (block 522). For example, if the student clicks on the exit button, another form is sent by the student server 108 to the student terminal 102. The form may contain questions such as “Why are you leaving?” After the student answers the questions, the student may then brought to a good bye screen (block 520), and can return to the institution home page (block 518).

After the student enters their contact information, they are asked if they have called in to the recruitment office or not (block 506). For example, the student server 108 may send a form asking “Have you called in?” The form may list the options “Yes” and “No.” If the student has called in previously, they are told that they are done with the online process (block 524) and can either call in again (block 526) or finish their session (block 520).

If the student has not called in previously, the school code and/or the media code (block 508) directs the student to a series of filtering questions (block 510). These filtering questions could include areas of interest, scholastic history, future goals, hobbies, etc. For example, the questions regarding the prospective student's scholastic history could ask for a gpa, graduation history, GED equivalency, etc. The questions regarding future goals could ask what the prospective student's employment goals are, future salary expectations, etc.

The student then selects an appointment (block 512) on an appointment selection screen 1000, described in more detail below. For example, a calendar could be displayed with available days highlighted. In another example, a listing of available times is displayed. The user may enter a range of times, and the system returns the available appointment slots. If the student cannot make any appointments, they are asked to call into the recruitment center 116 (block 526) on a call request page 1200, described in more detail below. Otherwise the student selects an appointment, and instructions are given (block 514) followed by directions (block 516) on a confirmation page 1100, described in more detail below. After the confirmation page 1100, the student is done (block 528) and taken to a final page (block 520). For example, the final screen (block 520) may display a message including instructions to call the recruitment center 116 if the student is interested in scheduling an appointment.

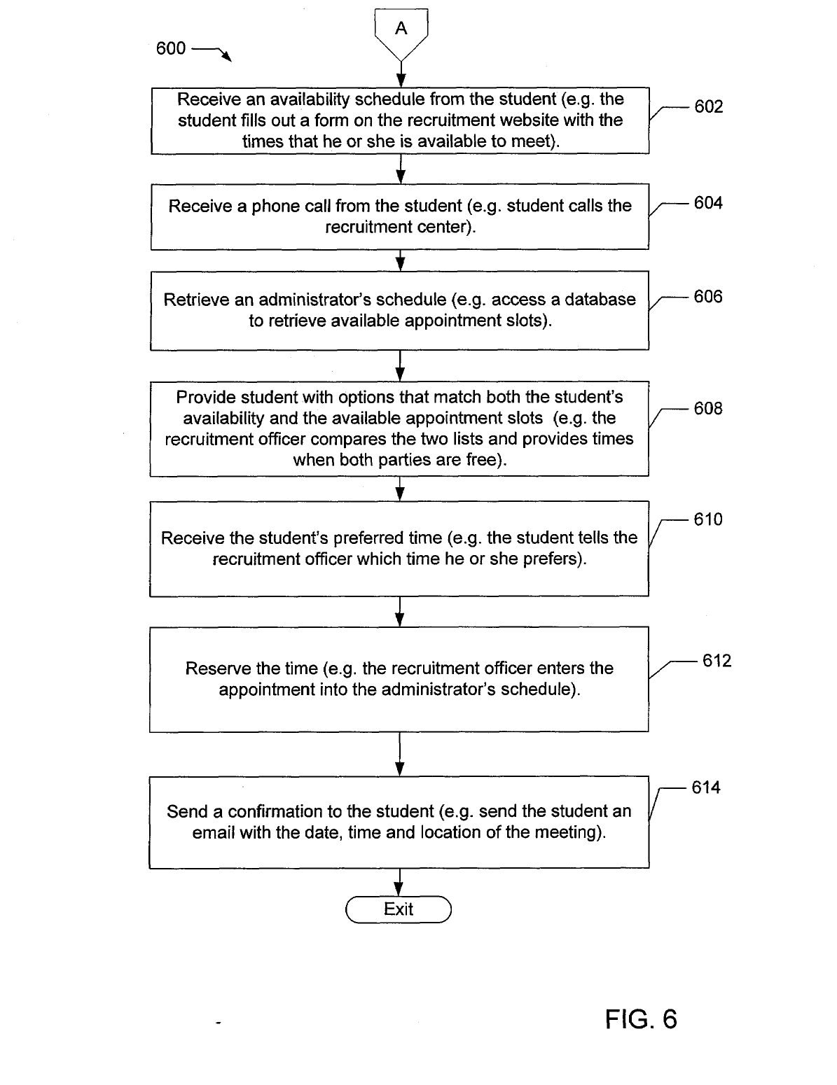

A flowchart of an example process 600 to schedule an appointment is shown in FIG. 6. Preferably, the process 600 is embodied in one or more software programs which is stored in one or more memories and executed by one or more processors. Although the process 600 is described with reference to the flowchart illustrated in FIG. 6, it will be appreciated that many other methods of performing the acts associated with process 600 may be used. For example, the order of many of the acts may be changed, and some of the acts described may be optional, additionally many acts could be added to the process 600.

In this example, the process 600 receives an availability schedule from the student (block 602). For example, the student may be at the student terminal 102 and accessing the recruitment website from the student server 108. The recruitment website may contain a scheduling page. The scheduling page may contain a form containing a selectable list of times that the student is available to meet. The scheduling page may also contain a calendar view allowing the student to select certain dates and times that he or she is available. The selection is transmitted from the student terminal 102 to the student server 108 via the internet or other network 112. The selection may be stored on the student database 110.

The process 600 then receives a phone call from the student (block 604). For example, the final screen (block 520) may contain a request for the student to call the recruitment center 116 in order to schedule an appointment. The prospective student may call the recruitment center 116 from the student phone 114.

In another embodiment, an outbound call is made as described in block 418 of process 400, and the recruitment officer speaks with the student.

The process 600 then retrieves the administrator's schedule (block 606). The recruitment terminal 106 may retrieve a list of all available administrator appointment slots. For example, the recruitment terminal 106 accesses the student database 110, which stores the available administrator appointment slots, via the internet or other network 112 and the student server 108. The recruitment terminal 106 may display a calendar view of all available administrator appointment slots.

The process 600 then provides the student with options that match both the student's availability and the available appointment slots (block 608). For example, the student server 108 transmits the student's availability from the student database 110 to the recruitment terminal 106. The recruitment officer may see both the student availability and the available appointment slots. The recruitment officer may then inform the student as to what options the student has. For example, if the recruitment terminal 106 displays that the student is available March 2 at 10:00 AM and that an administrator is available at the same time, the recruitment officer may inform the student that March 2 at 10:00 AM is available.

In another example, student server 108 analyzes both lists and only transmits times that are open to both parties. For example, the student serve 108 may process the list of available appointments and the student preferences and send a list of times where the student and administrator or administrators are free. The list may be displayed as a calendar. For example, the recruitment terminal 106 may display a month with available days shaded a certain color and the times written in the body of the calendar days.

The process 600 then receives the student's preferred time (block 610). For example, the student may tell the recruitment officer the student's preferred time over the student phone 114.

The process 600 then reserves the selected time (block 612). The recruitment officer may reserve the time on the recruitment terminal 106. For example, the recruitment officer may select the time from a list of times, or from a calendar view on the recruitment terminal 106. The recruitment terminal 106 may then send the selection from to the student server 108 via the internet or other network 112. The student server 108 may store the reservation on the student database 110.

The process 600 then sends a confirmation to the student (block 614). For example, the recruitment terminal 106 may send an email to the email address provided by the student via the internet or other network 112. The email may state the time, location and date of the appointment. The student server 108 may also send an email to the email address provided by the student via the internet or other network 112.

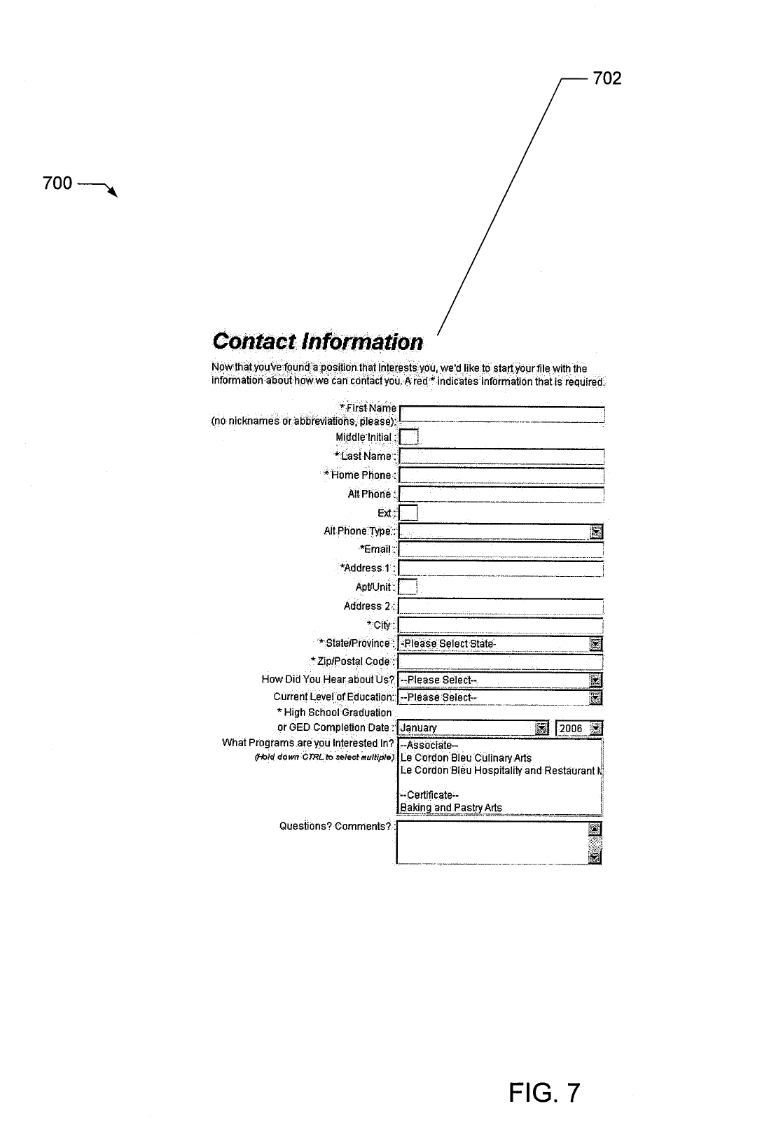

A screenshot of an example student information request page 700 is presented in FIG. 7. Although the student information request page is described in reference FIG. 7, it will be appreciated that many other configurations are possible. For example, elements could be in different locations, elements could have different names, and elements could have different graphical representations.

The student information request page may contain a student information form 702. For example, the student information form may ask for the student's name, address, phone number, email address, social security number, etc. The form may be displayed on the student terminal 102, and sent by the student server 108 via the internet or other network 112. The completed form may be sent to the student server 108 by the student terminal 102. The student server 108 may store the information on the form in the student database 110.

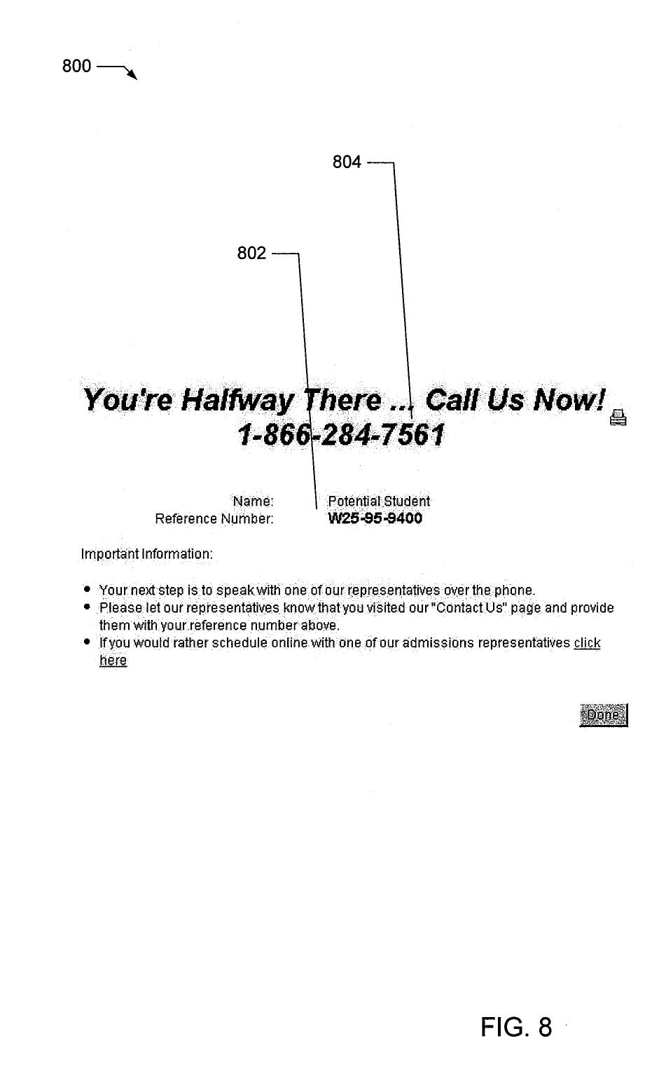

A screenshot of an example call request page 800 is presented in FIG. 8. Although the student information request page is described in reference FIG. 8, it will be appreciated that many other configurations are possible. For example, elements could be in different locations, elements could have different names, and elements could have different graphical representations.

The call request page 800 may include a reference number 802. For example, the reference number 802 may be an alphanumeric sequence that uniquely identifies the student. The call request page 800 may also include a phone number 804. For example, the phone number 804 may be a phone number associated with a recruitment center 116.

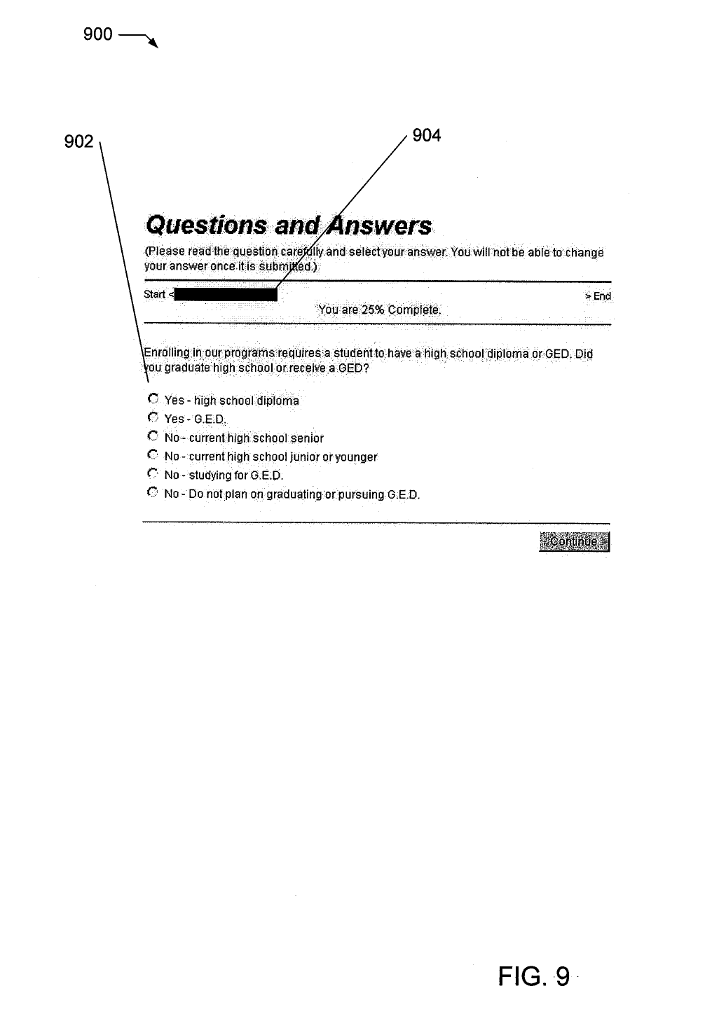

A screenshot of an example filtering question page 900 is presented in FIG. 9. Although the filtering question page 900 is described in reference FIG. 9, it will be appreciated that many other configurations are possible. For example, elements could be in different locations, elements could have different names, and elements could have different graphical representations.

The questions may be presented in a sequence. For example, the current question 902 may be sent from the student server 108 to the student terminal 102. Based on the student's response, the student server 108 chooses the next response. For example, if the student selects that he or she has not graduated high school, the next question may be “Do you have a GED?”

The questions may also be presented in groups. For example, a list of questions relating to the student's educational history may be displayed. The groups of questions may be educational history, ability to pay, interest areas, career focus, other schools applied to, extracurricular activities, estimated enrollment date, etc. The student may choose a response, or set of responses, on the student terminal 102 and the response is transmitted to the student server 108.

The filtering question page 900 may contain a status bar 904. For example, a graphical representation of the prospective student's progress through the total number of filtering questions may be displayed on the student terminal 102. The status bar 904 may also contain text information associated with the prospective student's progress through the total number of filtering questions. For example, the status bar 904 may state “You are 25% Complete.”

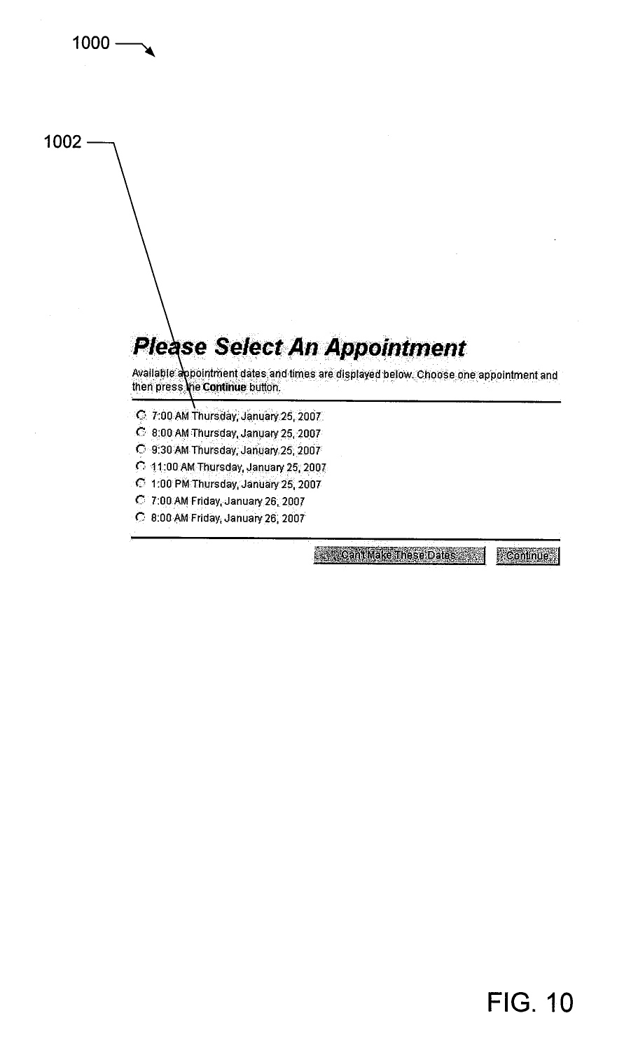

A screenshot of an example appointment scheduling page 1000 is presented in FIG. 10. Although the appointment scheduling page 1000 is described in reference FIG. 10, it will be appreciated that many other configurations are possible. For example, elements could be in different locations, elements could have different names, and elements could have different graphical representations.

For example, the available appointments display 1002 may be a list of times and may be displayed on the appointment scheduling page 1000. For example, the student server 108 may compare the student's preferred times from the student database 110 with the available administrator appointment slots from the student database 110. The student server 108 may then transmit the matching slots to the student terminal 102. The available appointments display 1002 may be depicted in another graphical representation. For example, the graphical representation may be a calendar, icons representing days, etc.

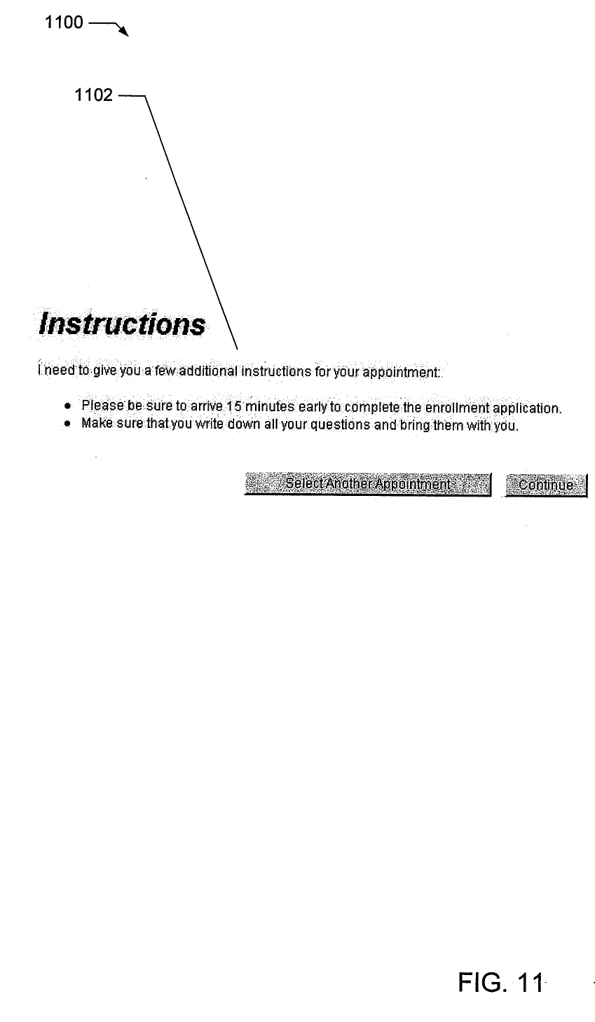

A screenshot of an instructions page 1100 is presented in FIG. 11. Although the instructions page 1100 is described in reference FIG. 11, it will be appreciated that many other configurations are possible. For example, elements could be in different locations, elements could have different names, and elements could have different graphical representations.

The instructions page 1100 may contain instruction information 1102. For example, the information may contain the prospective student's contact information, date of the appointment, instructions for the appointment, etc. An email notification may also be sent to the prospective student. For example, the student server 108 may transmit the confirmation page 1100 to the prospective student at the student terminal 102, as well as transmitting an email to the student at the student's email address via the internet or other network 112.

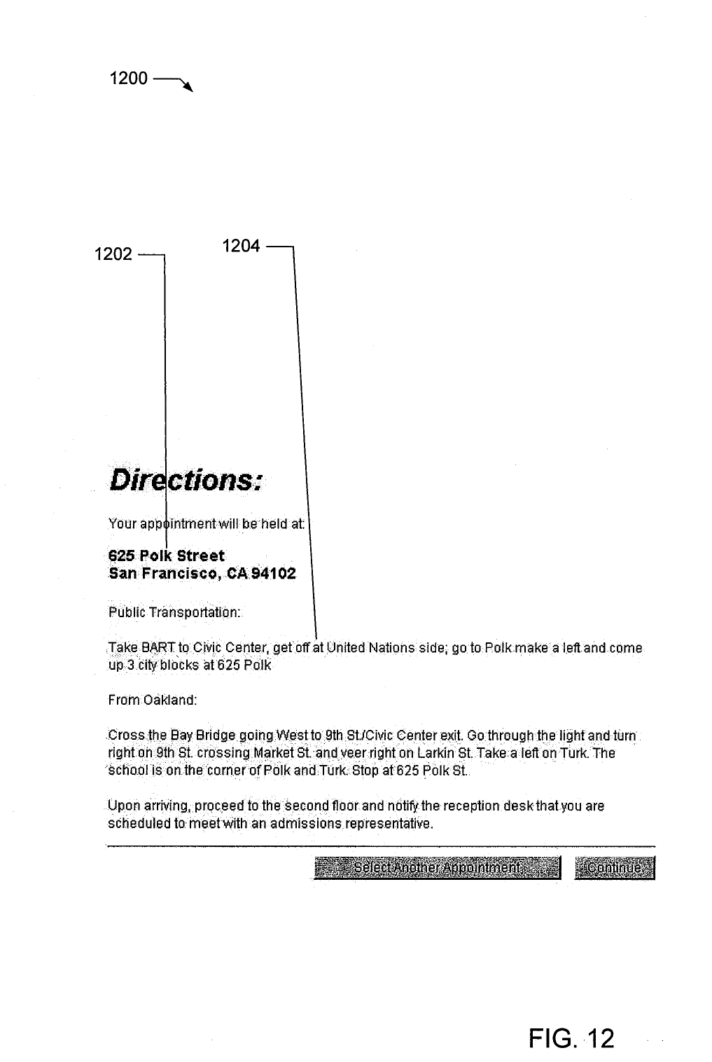

A screenshot of a confirmation page 1200 is presented in FIG. 12. Although the confirmation page 1200 is described in reference FIG. 12, it will be appreciated that many other configurations are possible. For example, elements could be in different locations, elements could have different names, and elements could have different graphical representations.

The confirmation page 1200 may display address information 1202. For example, the confirmation page 1200 may include the address of the building that the interview will take place in. The confirmation page 1200 may also include directions 1204. For example, the confirmation page 1200 may include directions to the address 1202.

It will be readily appreciated that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for recruiting students comprising:
storing school availability data in at least one server;
receiving a student phone number and student availability data at the at least one server;
sending a signal from the at least one server to a student terminal, the message being structured to cause the student terminal to display a message asking the student to place a call to a recruitment center;
waiting a period of time for the student to place the call to the recruitment center;
automatically generating an outbound call to the student at the phone number if the period of time is exceeded without a call from the student; and
scheduling an appointment with the student using the student availability data and the school availability data.

2. The method of claim 1, including:
providing a list of filtering questions to the student; and
storing student responses to the filtering questions in the server.

3. The method of claim 2, including determining a list of unanswered questions and analyzing the list to determine a list of effective questions.

4. The method of claim 1, including receiving a media reference code from the student, the media reference code being a code associated with a media advertisement.

5. The method of claim 4, including analyzing a plurality of media codes to determine effective advertisements.

6. A method for recruiting students comprising:
storing school availability data in at least one server;
receiving a student phone number and student availability data at the at least one server;
sending a signal from the at least one server to a student terminal, the message being structured to cause the student terminal to display a message asking the student to place a call to a recruitment center;
receiving a request from the student to call immediately;
automatically generating an outbound call to the student at the phone number; and
scheduling an appointment with the student using the student availability data and the school availability data.

7. The method of claim 6, including:
providing a list of filtering questions to the student; and
storing student responses to the filtering questions in the server.

8. The method of claim 7, including determining a list of unanswered questions and analyzing the list to determine a list of effective questions.

9. The method of claim 6, including receiving a media reference code from the student, the media reference code being a code associated with a media advertisement.

10. The method of claim 9, including analyzing a plurality of media codes to determine effective advertisements.

11. An apparatus for recruiting students comprising:
a processing unit; and
a memory device operatively coupled to the processing unit, the memory device storing software instructions structured to cause the processing unit to:
store school availability data in at least one server;
receive a student phone number and student availability data at the at least one server;
send a signal from the at least one server to a student terminal, the message being structured to cause the student terminal to display a message asking the student to place a call to a recruitment center;
wait a period of time for the student to place the call to the recruitment center;
automatically generate an outbound call to the student at the phone number if the period of time is exceeded without a call from the student; and
schedule an appointment with the student using the student availability data and the school availability data.

12. The apparatus of claim 11, wherein the software instructions are structured to cause the processing unit to:
provide a list of filtering questions to the student; and
store student responses to the filtering questions in the server.

13. The apparatus of claim 12, wherein the software instructions are structured to cause the processing unit to determine a list of unanswered questions and analyze the list to determine a list of effective questions.

14. The apparatus of claim 11, wherein the software instructions are structured to cause the processing unit to receive a media reference code from the student, the media reference code being a code associated with a media advertisement.

15. The apparatus of claim 14, wherein the software instructions are structured to cause the processing unit to analyze a plurality of media codes to determine effective advertisements.

16. An apparatus for recruiting students comprising:
a processing unit; and
a memory device operatively coupled to the processing unit, the memory device storing software instructions structured to cause the processing unit to:
store school availability data in at least one server;
receive a student phone number and student availability data at the at least one server;
send a signal from the at least one server to a student terminal, the message being structured to cause the student terminal to display a message asking the student to place a call to a recruitment center;
receive a request from the student to call immediately;
automatically generate an outbound call to the student at the phone number; and
schedule an appointment with the student using the student availability data and the school availability data.

17. The apparatus of claim 16, wherein the software instructions are structured to cause the processing unit to:
provide a list of filtering questions to the student; and
store student responses to the filtering questions in the server.

18. The apparatus of claim 17, wherein the software instructions are structured to cause the processing unit to determine a list of unanswered questions and analyze the list to determine a list of effective questions.

19. The apparatus of claim 16, wherein the software instructions are structured to cause the processing unit to receive a media reference code from the student, the media reference code being a code associated with a media advertisement.

20. The apparatus of claim 19, wherein the software instructions are structured to cause the processing unit to analyze a plurality of media codes to determine effective advertisements.
